(19) United States
(12) Patent Application Publication
(10) Pub. No.: US 2026/0185700 A1
(43) Pub. Date: Jul. 2, 2026

(54) AMMONIA COMBUSTION FURNACE

(71) Applicant: KAWASAKI JUKOGYO KABUSHIKI KAISHA, Kobe-shi, Hyogo (JP)

(72) Inventors: Taishin YAMAGUCHI, Kobe-shi (JP); Koji TANIGUCHI, Kobe-shi (JP); Atsunori KATO, Kobe-shi (JP); Suguru YABARA, Kobe-shi (JP)

(73) Assignee: KAWASAKI JUKOGYO KABUSHIKI KAISHA, Kobe-shi, Hyogo (JP)

(21) Appl. No.: 18/860,972

(22) PCT Filed: Jun. 13, 2023
(86) PCT No.: PCT/JP2023/021840

§ 371 Date: Oct. 28, 2024

(30) Foreign Application Priority Data
Jun. 3, 2022 (JP) 2022-091145

(51) Int. Cl. F23C 6/04; F23L 9/00

(52) U.S. Cl. CPC F23C 6/04; F23L 9/00

(57) ABSTRACT

An ammonia combustion furnace includes: a furnace body including a first combustion chamber in which fuel containing ammonia is combusted at a temperature of 1,400° C. or more and 1,600° C. or less in a reduction atmosphere and a second combustion chamber which is connected to the first combustion chamber and includes an inlet into which a burned gas and an unburned portion of the fuel flow from the first combustion chamber, the unburned portion being combusted at a temperature of 1,300° C. or less in the second combustion chamber; a burner that supplies the fuel and first-stage combustion air to the first combustion chamber; and second-stage combustion air nozzles that supply second-stage combustion air to the second combustion chamber.

### TECHNICAL FIELD

The present disclosure relates to a combustion furnace that uses ammonia as part of fuel or as entire fuel.

### BACKGROUND ART

In recent years, ammonia is attracting attention as CO₂-free fuel that does not emit carbon dioxide. When the ammonia is pressurized, it liquefies even at normal temperature. Therefore, the ammonia is easier to handle than hydrogen that is also the CO₂-free fuel. However, for example, there are problems that as compared to the hydrogen and conventional fuel, the ammonia is hardly ignited, a combustion speed of the ammonia is slow, and nitrogen oxide (NOx) is generated in a combustion process of the ammonia. To solve such problems, a technology of suppressing the NOx emitted from a combustion furnace (boiler furnace, for example) that uses the ammonia as the fuel has been proposed.

For example, PTL 1 proposes a multi-fuel fired boiler in which: pulverized coal and ammonia are used; burners are included in a furnace; the burners located at a most downstream stage are pulverized coal burners; and the burners located at the other stages are multi-fuel fired burners that use pulverized coal and ammonia. According to this multi-fuel fired boiler, since a residence time of the ammonia is secured, the emission of unburned ammonia and nitrous oxide is suppressed. In addition, since nitrogen oxide is decomposed by reduction materials generated by the burners of the respective stages, the emission of the nitrogen oxide is suppressed.

### CITATION LIST

### Patent Literature

PTL 1: Japanese Laid-Open Patent Application Publication No. 2020-112280

### SUMMARY OF INVENTION

### Technical Problem

To stably use the ammonia as the fuel, problems are “ignition and flame holding” in addition to the above-described “NOx reduction.” To realize the “NOx reduction,” an ammonia mixed fuel burning ratio may be lowered. However, this deteriorates the effect of suppressing the emission of the carbon dioxide. Moreover, when the ammonia mixed fuel burning ratio is high, and a combustion improving effect of the other fuel is low, the “ignition and flame holding” are difficult, a countermeasure by which the flame holding is realized by the ammonia alone is required. As above, the “ignition and flame holding” and the “NOx reduction” are generally in the relationship of trade-off.

The present disclosure was made under these circumstances, and an object of the present disclosure is to propose a combustion furnace which uses ammonia as part of fuel or as entire fuel and realizes both of the ignition and flame holding and the NOx reduction.

### Solution to Problem

In order to solve the above problems, an ammonia combustion furnace according to the present disclosure includes:
a furnace body including
   a first combustion chamber in which fuel containing ammonia is combusted at a temperature of 1,400° C. or more and 1,600° C. or less in a reduction atmosphere and
   a second combustion chamber which is connected to the first combustion chamber and includes an inlet into which a burned gas and an unburned portion of the fuel flow from the first combustion chamber, the unburned portion being combusted at a temperature of 1,300° C. or less in the second combustion chamber;
a burner that supplies the fuel and first-stage combustion air to the first combustion chamber; and
second-stage combustion air nozzles that supply second-stage combustion air to the second combustion chamber.

### Advantageous Effects of Invention

According to the present disclosure, in the combustion furnace which uses the ammonia as part of the fuel or as the entire fuel, both of the ignition and flame holding and the NOx reduction may be realized.

### BRIEF DESCRIPTION OF DRAWINGS

FIG. 1 is a schematic diagram showing the configuration of a boiler including an ammonia combustion furnace according to one embodiment of the present disclosure.

FIG. 2 is a diagram showing the configuration of the boiler including the ammonia combustion furnace according to Modified Example.

FIG. 3 is a diagram for explaining a combustion method of the ammonia combustion furnace.

FIG. 4 is a diagram for explaining Modified Example of the combustion method of the ammonia combustion furnace.

### DESCRIPTION OF EMBODIMENTS

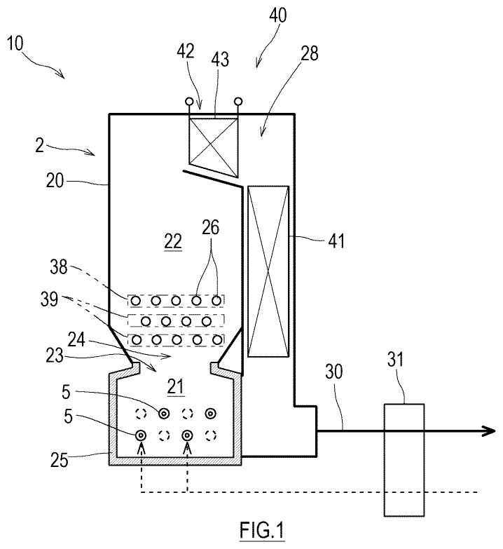

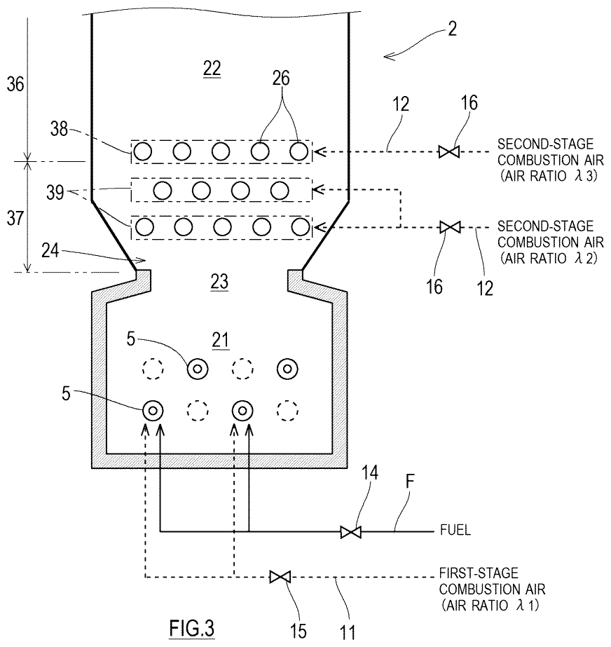

Hereinafter, an ammonia combustion furnace 2 according to one embodiment of the present disclosure will be described with reference to the drawings. FIG. 1 is a schematic diagram showing the configuration of a boiler 10 including the ammonia combustion furnace (hereinafter simply referred to as the “combustion furnace 2”) according to one embodiment of the present disclosure. FIG. 3 is a diagram for explaining a combustion method of the combustion furnace 2. The combustion furnace 2 according to the present embodiment is a furnace of the boiler 10. However, the configuration of the combustion furnace 2 according to the present disclosure is not limited to a boiler furnace and is widely applicable to a combustion furnace that uses ammonia as part of fuel or as entire fuel.

### Schematic Configuration of Boiler 10

The boiler 10 shown in FIG. 1 includes: the combustion furnace 2 that combusts fuel containing ammonia; and a boiler main body 40 and a superheater 42 which generates steam by utilizing combustion heat of the fuel. The boiler 10 is a thermal power boiler and uses the fuel containing the ammonia. In addition to the ammonia, the fuel may contain fuel, such as pulverized coal, which has been used in conventional thermal power boilers.

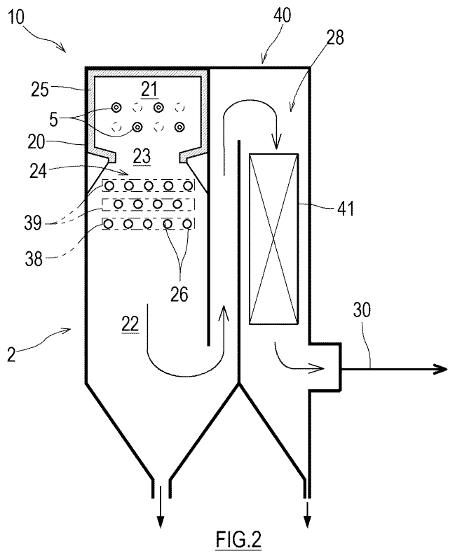

The combustion furnace 2 includes a vertical furnace body 20, and the furnace body 20 includes combustion chambers 21 and 22 therein. A first combustion chamber 21 having a high-temperature reduction atmosphere is located at a lower portion of the furnace body 20. A second combustion chamber 22 most of which has a low-temperature oxidizing atmosphere is located at an upper side of the first combustion chamber 21. A throat 23 is located between the first combustion chamber 21 and the second combustion chamber 22. However, as shown in FIG. 2, the combustion furnace 2 may be such that: the first combustion chamber 21 is located at an upper portion of the furnace body 20; and the second combustion chamber 22 is located at the lower portion of the furnace body 20. FIG. 2 is a diagram showing the configuration of the boiler 10 including the combustion furnace 2 according to Modified Example. In the drawings, the same reference signs are used for the same or similar members as the boiler 10 of FIG. 1, and explanations thereof are omitted.

As shown in FIGS. 1 and 3, an inner wall of the first combustion chamber 21 of the furnace body 20 is covered with a fire-resistant material 25. The fire-resistant material 25 may cover the entire first combustion chamber 21 or may cover part of the first combustion chamber 21. The fire-resistant material 25 may be resistant to a high temperature of about 2,000° C. Burners 5 which inject fuel F and combustion air (hereinafter referred to as first-stage combustion air 11) into the first combustion chamber 21 are located at a furnace wall of the first combustion chamber 21. Each burner 5 may be an ammonia single-fuel combustion burner that uses only the ammonia as the fuel F. Or, each burner 5 may be an ammonia multi-fuel combustion burner in which an ammonia mixed fuel burning ratio is 50% or more based on a lower heating value (LHV). To be specific, the burners 5 use the ammonia as main fuel. The ammonia single-fuel combustion burner having a known configuration and the ammonia multi-fuel combustion burner having a known configuration are adoptable.

The fuel F injected from the burners 5 is mixed with the first-stage combustion air 11 and combusted, and this generates flame. The amount of fuel supplied to the burners 5 can be adjusted by a fuel supply valve 14. Moreover, the amount of first-stage combustion air 11 supplied to the burners 5 can be adjusted by a first-stage combustion air supply valve 15. The fuel supply valve 14 and the first-stage combustion air supply valve 15 may be flow regulating valves located at supply pipes extending to the burners 5.

The burners 5 are located at a pair of opposing furnace walls. At least one burner stage in an upper-lower direction is located at each furnace wall, and each burner stage includes the burners 5 lined up in a horizontal direction. The burners 5 located so as to be opposed to each other as above are located in zigzag so as to be opposed to each other such that burner axes of the burners 5 do not intersect with each other.

An outlet of the first combustion chamber 21 (i.e., an upper portion of the first combustion chamber 21) is connected to an inlet of the second combustion chamber 22 (i.e., a lower portion of the second combustion chamber 22) through the throat 23. A smallest horizontal sectional area of the throat 23 is about 20% to 50% of a horizontal sectional area of the first combustion chamber 21.

Second-stage combustion air nozzles 26 are located at a furnace wall of the second combustion chamber 22. Second-stage combustion air (hereinafter referred to as second-stage combustion air 12) is injected from each second-stage combustion air nozzle 26 into the second combustion chamber 22. The amount of second-stage combustion air 12 supplied to the second combustion chamber 22 can be adjusted by a second-stage combustion air supply valve 16. The second-stage combustion air supply valve 16 may be, for example, a flow regulating valve located at an air supply pipe connected to the second-stage combustion air nozzles 26.

The second-stage combustion air nozzles 26 are lined up in a lateral direction to form one nozzle stage. Nozzle stages 38 and 39 lined up in the upper-lower direction are located at the second combustion chamber 22. Among the nozzle stages 38 and 39, a nozzle stage located at a most downstream side along the flow of the gas in the furnace is referred to as an “most downstream nozzle stage 38.” Moreover, among the nozzle stages 38 and 39, nozzle stages located between the inlet of the second combustion chamber 22 and the most downstream nozzle stage 38 in the upper-lower direction are referred to as “intermediate nozzle stages 39.” The combustion furnace 2 according to the present embodiment includes two intermediate nozzle stages 39. However, the number of intermediate nozzle stages 39 may be one or more.

A portion of the second combustion chamber 22 which is located between the throat 23 and the most downstream nozzle stage 38 in the upper-lower direction is a cooling portion 24. A furnace wall of the cooling portion 24 is a water cooled wall at which a water pipe (not shown) of the boiler main body 40 extends.

An outlet of the second combustion chamber 22 (i.e., an upper portion of the second combustion chamber 22) is connected to an inlet of a flue 28 located at an upper portion of the combustion furnace 2. A superheater pipe 43 of the superheater 42 is located at an upstream portion of the flue 28. Moreover, a water pipe 41 of the boiler main body 40 extends at a wall of the flue 28. An exhaust gas treatment system 30 is connected to an outlet of the flue 28. A heat exchanger 31 that utilizes the remaining heat of a flue gas to preheat air to be supplied to the burners 5 is located at the exhaust gas treatment system 30.

### Combustion Method of Combustion Furnace 2

The following will describe a combustion method of the combustion furnace 2 configured as above. As shown in FIG. 3, a zone of the second combustion chamber 22 which is located between the inlet and the most downstream nozzle stage 38 in the upper-lower direction is referred to as a “NOx suppression combustion zone 37,” and a zone of the second combustion chamber 22 which is located above the most downstream nozzle stage 38 is referred to as a “complete combustion zone 36.” The NOx suppression combustion zone 37 is located upstream of the complete combustion zone 36 along the flow of the gas.

The first-stage combustion air 11 and the fuel F containing the ammonia are injected from the burners 5. The first-stage combustion air 11, the amount of which is set such that an air ratio to the supplied fuel F becomes λ1, is supplied to the first combustion chamber 21. The air ratio is a numerical value obtained by dividing the amount of supplied air by a theoretical amount of air with respect to the amount of fuel F supplied. When the air ratio is one, the air combusts without excess or insufficiency. When the air ratio is smaller than one, the air is insufficient. When the air ratio is larger than one, the air is excessive. The amount of fuel F supplied is determined with respect to a required heat input, and the theoretical amount of air with respect to the amount of fuel F supplied may be obtained by calculation. The air ratio λ1 is not less than 0.6 and less than 0.9, desirably not less than 0.65 and not more than 0.75. Then, the amount of first-stage combustion air 11 supplied is adjusted by the first-stage combustion air supply valve 15 such that the first-stage combustion air 11, the amount of which is set such that the air ratio becomes the given air ratio λ1, is supplied to the first combustion chamber 21.

A furnace internal temperature of the first combustion chamber 21 covered with the fire-resistant material 25 hardly lowers as compared to the other portion of the furnace. Therefore, the first combustion chamber 21 has a high-temperature reduction atmosphere of about 1,500° C. on average, and the combustion of the fuel F is promoted in the first combustion chamber 21. A combustion temperature of the first combustion chamber 21 is desirably about 1,500° C. on average, but may be kept in a range of not less than 1,400° C. and not more than 1,600° C., more preferably in a range of more than 1,500° C. and not more than 1,600° C. The combustion temperature of the fuel of a conventional boiler furnace is about 1,100° C. to 1,300° C., and the temperature of the first combustion chamber 21 is adequately higher than this.

As compared to conventional fuel, the ammonia is hardly ignited, and a combustion speed of the ammonia is slow. However, according to the combustion furnace 2 of the present disclosure, the ammonia is combusted in the first combustion chamber 21 that is higher in temperature than typical boiler furnaces. Therefore, the ammonia is stably combusted even in a low oxygen atmosphere. Moreover, since the ammonia contains a large amount of hydrogen, a large amount of steam is generated by the combustion of the fuel. Then, the generated steam serves as a gasifying agent, and unburned carbon in the combustion gas causes a water gas shift reaction.

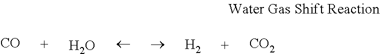

The water gas shift reaction is a reversible reaction. However, in a temperature range of 1,000° C. or more, the reaction is activated toward a product side (to the right in the above formula). Moreover, it is known that in the temperature range of 1,000° C. or more, a reaction rate of the water gas shift reaction increases as the temperature increases. In a range of 1,400° C. or more and 1,600° C. or less in the first combustion chamber 21, the water gas shift reaction is active, and this improves the combustion efficiency. As above, in the combustion furnace 2 according to the present disclosure, even when the ammonia mixed fuel burning ratio is 50% to 99% which is higher than a conventional ratio, or even in the ammonia single-fuel combustion (100% of ammonia), the ignition and flame holding of the ammonia are realized. According to conventional ammonia multi-fuel combustion burners, the ammonia mixed fuel burning ratio is about 20% at most.

Since the first combustion chamber 21 has the reduction atmosphere (low oxygen atmosphere), the generation of the NOx by the combustion of the ammonia is suppressed. Moreover, even when the entire first-stage combustion air 11 has reacted in the first combustion chamber 21, part of the fuel F remains unburned. In the first combustion chamber 21, a high-temperature gas that is a mixture of a burned gas generated by the combustion of the fuel F and an unburned portion of the fuel F is generated. This high-temperature gas flows through the throat 23 into the second combustion chamber 22 and first meets in the NOx suppression combustion zone 37 the second-stage combustion air 12 which has been injected from the second-stage combustion air nozzles 26 of the intermediate nozzle stages 39. The unburned portion in the high-temperature gas is combusted by oxygen contained in the second-stage combustion air 12. The cooling portion 24 exists between the first combustion chamber 21 and the second combustion chamber 22, and the combustion temperature of the second combustion chamber 22 is about 1,300° C. or less which is lower than that of the first combustion chamber 21.

The second-stage combustion air nozzles 26 of the intermediate nozzle stages 39 inject the second-stage combustion air 12 the amount of which is set such that the air ratio to the amount of fuel F supplied becomes 22. The air ratio λ2 is such a value that the sum of the air ratios λ1 and λ2 is less than one [(λ1+λ2)<1]. When the air ratio λ2 is excessively low, the combustion does not occur. Therefore, it is desirable that the air ratio λ2 be a value larger than 0.1. For example, when the air ratio λ1 is 0.7, the air ratio λ2 is a value of 0.1 or more and less than 0.3. Then, the amount of second-stage combustion air 12 supplied is adjusted by the second-stage combustion air supply valve 16 such that the second-stage combustion air 12, the amount of which is set such that the air ratio becomes the given air ratio λ2, is supplied to the NOx suppression combustion zone 37.

The sum of the air ratios λ1 and λ2 is less than one. Therefore, in the NOx suppression combustion zone 37, the combustion is performed in the reduction atmosphere. Then, the bonding of oxygen and nitrogen is suppressed, and the generation of the NOx is suppressed. Moreover, since the sum of the air ratios λ1 and λ2 is less than one, the unburned portion remains in the high-temperature gas which has flowed through the NOx suppression combustion zone 37. This high-temperature gas flows into the complete combustion zone 36 and meets the second-stage combustion air 12 which has been injected from the second-stage combustion air nozzles 26 of the most downstream nozzle stage 38. Thus, the unburned portion in the high-temperature gas is completely combusted.

The second-stage combustion air nozzles 26 of the most downstream nozzle stage 38 supply to the complete combustion zone 36 the second-stage combustion air 12 the amount of which is set such that the air ratio to the amount of fuel F supplied becomes λ3. The air ratio λ3 is such a value that the sum of the air ratios λ1, λ2, and λ3 is larger than one [(λ1+λ2+λ3)>1], desirably larger than 1.1. Then, the amount of second-stage combustion air 12 supplied is adjusted by the second-stage combustion air supply valve 16 such that the second-stage combustion air 12, the amount of which is set such that the air ratio becomes the given air ratio λ3, is supplied from the most downstream nozzle stage 38 to the complete combustion zone 36. The complete combustion zone 36 has the oxidizing atmosphere, and the combustion of the unburned portion in the high-temperature gas is promoted in the complete combustion zone 36.

In the second combustion chamber 22, the combustion of the unburned portion in the high-temperature gas which has flowed out from the first combustion chamber 21 is completed (i.e., complete combustion is performed). The flue gas from the second combustion chamber 22 flows out through the flue 28 to the exhaust gas treatment system 30. The heat of the flue gas is collected by the water pipe 41 located at the flue 28, and the steam is generated by the boiler main body 40. Moreover, the heat of the flue gas is collected by the superheater pipe 43 located the flue 28, and the superheated steam is generated by the superheater 42. The generated superheated steam is utilized by, for example, a steam turbine of a power generation facility.

### Modified Example

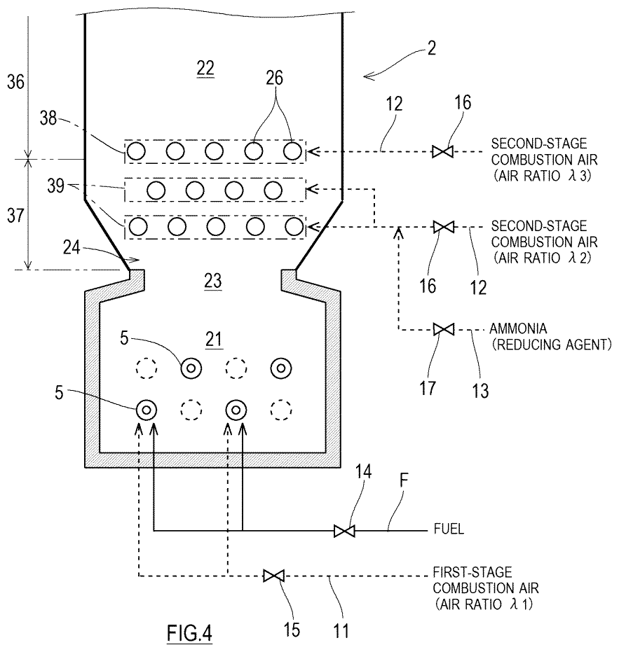

FIG. 4 is a diagram for explaining Modified Example of the combustion method of the ammonia combustion furnace 2. In the above-described combustion method of the combustion furnace 2, the second-stage combustion air 12 is injected from the second-stage combustion air nozzles 26 of the intermediate nozzle stages 39. However, as shown in FIG. 4, a small amount of ammonia 13 as a reducing agent may be mixed with the second-stage combustion air 12 injected from the second-stage combustion air nozzles 26 of the intermediate nozzle stages 39. The gas injected from the second-stage combustion air nozzles 26 of the intermediate nozzle stages 39 is a mixture gas which contains the second-stage combustion air 12 and the ammonia 13 and has an ammonia mixing ratio of less than 15%. A combustible range of the ammonia in the air is 15-28% by volume under normal pressure at normal temperature. The NOx suppression combustion zone 37 is the cooling portion 24 surrounded by the water cooled wall, and the temperature of the high-temperature gas has lowered to such a temperature (850° C. or more and 1,300° C. or less) that the ammonia serves as the reducing agent. Therefore, in the NOx suppression combustion zone 37, the ammonia which accompanies the second-stage combustion air 12 and has a concentration lower than the combustible range serves as the reducing agent of the NOx. The NOx in the high-temperature gas contacts the ammonia 13 which accompanies the second-stage combustion air 12. Thus, the NOx is decomposed into nitrogen and water. As above, the gas injected from the second-stage combustion air nozzles 26 of the intermediate nozzle stages 39 may be the second-stage combustion air 12. However, when a small amount of ammonia 13 is mixed with the second-stage combustion air 12, denitration occurs, and the emission of the NOx from the combustion furnace 2 can be more effectively suppressed.

In the combustion furnace 2, the ratio of the ammonia supplied from the burners 5 and the second-stage combustion air nozzles 26 to the furnace can be changed. The amount of fuel F which contains the ammonia and is injected from the burners 5 into the furnace can be adjusted by changing the opening degree of the fuel supply valve 14. Moreover, the amount of ammonia 13 which is supplied as the reducing agent and mixed with the second-stage combustion air 12 injected from the second-stage combustion air nozzles 26 of the intermediate nozzle stages 39 can be adjusted by an ammonia supply valve 17 located at a supply system of the ammonia 13 which is connected to the second-stage combustion air nozzles 26. Furthermore, the amount of combustion air supplied from the second-stage combustion air nozzles 26 of the intermediate nozzle stages 39 to the furnace can be adjusted by the second-stage combustion air supply valve 16 located at a supply system of the second-stage combustion air 12. Then, the flow rate of the ammonia 13 which is adjusted by the ammonia supply valve 17 is adjusted with respect to the flow rate of the supplied second-stage combustion air 12 such that the ammonia mixing ratio of the fuel-air mixture which contains the second-stage combustion air 12 and the ammonia 13 and is injected from the second-stage combustion air nozzles 26 is less than the combustible range of the ammonia. The ammonia mixing ratio of the fuel-air mixture which contains the second-stage combustion air 12 and the ammonia 13 and is injected from the second-stage combustion air nozzles 26 may be adjusted based on the concentration of the NOx which is detected by a NOx sensor located at the exhaust gas treatment system 30 of the combustion furnace 2. For example, when the amount of NOx emitted increases, the ammonia mixing ratio may be set to be higher than that at the time of a steady operation. Moreover, when the amount of NOx emitted decreases, the ammonia mixing ratio may be set to be lower than that at the time of the steady operation.

### CONCLUSION

The ammonia combustion furnace 2 according to a first aspect of the present disclosure includes:
the furnace body 20 including
   the first combustion chamber 21 in which the fuel F containing the ammonia is combusted at a temperature of 1,400° C. or more and 1,600° C. or less in a reduction atmosphere and
   the second combustion chamber 22 which is connected to the first combustion chamber 21 and includes the inlet into which the burned gas and the unburned portion of the fuel F flow from the first combustion chamber 21, the unburned portion being combusted at a temperature of 1,300° C. or less in the second combustion chamber 22;
the burner 5 that supplies the fuel F and the first-stage combustion air 11 to the first combustion chamber 21; and
the second-stage combustion air nozzles 26 that supply the second-stage combustion air 12 to the second combustion chamber 22.

According to the combustion furnace 2 configured as above, since the ammonia fuel is combusted at a high temperature of 1,400° C. or more and 1,600° C. or less, stable ignition and flame holding can be realized even in the reduction atmosphere (low oxygen atmosphere). Moreover, since the ammonia fuel combusts in the reduction atmosphere, the generation of the NOx can be suppressed.

The ammonia combustion furnace 2 according to a second aspect of the present disclosure is configured such that in the ammonia combustion furnace 2 according to the first aspect, the burner 5 is an ammonia single-fuel combustion burner or an ammonia multi-fuel combustion burner in which an ammonia mixed fuel burning ratio is 50% or more based on a lower heating value (LHV).

According to the combustion furnace 2 configured as above, since the ammonia fuel is combusted at a high temperature, stable ignition and flame holding can be realized even in the ammonia single-fuel combustion in which auxiliary fuel is not used and in the ammonia multi-fuel combustion in which the amount of auxiliary fuel used is small.

The ammonia combustion furnace 2 according to a third aspect of the present disclosure is configured such that in the ammonia combustion furnace 2 according to the first or second aspect, the ammonia combustion furnace 2 includes the most downstream nozzle stage 38 and at least one intermediate nozzle stage 39 located between the inlet of the second combustion chamber 22 and the most downstream nozzle stage 38, each nozzle stage including the second-stage combustion air nozzles 26 lined up in a lateral direction, wherein:
a zone from the inlet of the second combustion chamber 22 to the most downstream nozzle stage 38 is defined as the NOx suppression combustion zone 37; and
the second-stage combustion air 12, the amount of which is set such that an atmosphere in the NOx suppression combustion zone 37 becomes a reduction atmosphere, is supplied from the intermediate nozzle stage 39.

According to the combustion furnace 2 configured as above, since the unburned portion is combusted in the reduction atmosphere in the NOx suppression combustion zone 37, the generation of the NOx can be suppressed.

The ammonia combustion furnace 2 according to a fourth aspect of the present disclosure is configured such that in the ammonia combustion furnace 2 according to the third aspect, the intermediate nozzle stage 39 includes the second-stage combustion air nozzle 26 that supplies the fuel-air mixture containing the second-stage combustion air 12 and the ammonia 13 of less than the combustible range.

According to the combustion furnace 2 configured as above, the ammonia supplied from the intermediate nozzle stage 39 serves as the reducing agent that reduces the NOx. Therefore, the NOx emitted from the combustion furnace 2 can be further reduced.

The ammonia combustion furnace 2 according to a fifth aspect of the present disclosure is configured such that in the ammonia combustion furnace 2 according to any one of the second to fourth aspects, the sum of the air ratio λ1 of the first-stage combustion air 11 to the amount of fuel F supplied and the air ratio λ2 of the second-stage combustion air 12 to the amount of fuel F supplied from the intermediate nozzle stage 39 is less than one.

According to the combustion furnace 2 configured as above, since the unburned portion is combusted in the reduction atmosphere in the first combustion chamber 21 and the NOx suppression combustion zone 37 of the second combustion chamber 22, the generation of the NOx can be suppressed.

The combustion furnace 2 according to a sixth aspect of the present disclosure is configured such that in the ammonia combustion furnace 2 according to the fifth aspect, the sum of the air ratio λ1 of the first-stage combustion air 11 to the amount of fuel F supplied, the air ratio λ2 of the second-stage combustion air 12 supplied from the intermediate nozzle stage 39, and the air ratio λ3 of the second-stage combustion air 12 supplied from the most downstream nozzle stage 38 is larger than one.

According to the combustion furnace 2 configured as above, an atmosphere at the downstream side of the most downstream nozzle stage 38 becomes the oxidizing atmosphere, and the combustion of the fuel F is promoted. Thus, the fuel F can be prevented from remaining after the combustion.

The foregoing discussion of the present disclosure has been presented for purposes of illustration and description. The foregoing is not intended to limit the present disclosure to the form or forms disclosed herein. In the foregoing Detailed Description for example, various features of the present disclosure are grouped together in one embodiment for the purpose of streamlining the disclosure. However, some of the features may be combined with each other. The features of the present disclosure may be combined in alternate embodiments, configurations, or aspects other than those discussed above.

1. An ammonia combustion furnace comprising:
a furnace body including
a first combustion chamber in which fuel containing ammonia is combusted at a temperature of 1,400° C. or more and 1,600° C. or less in a reduction atmosphere and
a second combustion chamber which is connected to the first combustion chamber and includes an inlet into which a burned gas and an unburned portion of the fuel flow from the first combustion chamber, the unburned portion being combusted at a temperature of 1,300° C. or less in the second combustion chamber;
a burner that supplies the fuel and first-stage combustion air to the first combustion chamber; and
second-stage combustion air nozzles that supply second-stage combustion air to the second combustion chamber.

2. The ammonia combustion furnace according to claim 1, wherein the burner is an ammonia single-fuel combustion burner or an ammonia multi-fuel combustion burner in which an ammonia mixed fuel burning ratio is 50% or more based on a lower heating value.

3. The ammonia combustion furnace according to claim 1, comprising a most downstream nozzle stage and at least one intermediate nozzle stage located between the inlet of the second combustion chamber and the most downstream nozzle stage, each nozzle stage including the second-stage combustion air nozzles lined up in a lateral direction, wherein:
a zone from the inlet of the second combustion chamber to the most downstream nozzle stage is defined as a NOx suppression combustion zone; and
the second-stage combustion air, the amount of which is set such that an atmosphere in the NOx suppression combustion zone becomes a reduction atmosphere, is supplied from the intermediate nozzle stage.

4. The ammonia combustion furnace according to claim 3, wherein the intermediate nozzle stage includes the second-stage combustion air nozzle that supplies a fuel-air mixture containing the second-stage combustion air and the ammonia of less than a combustible range.

5. The ammonia combustion furnace according to claim 3, wherein a sum of an air ratio of the first-stage combustion air to the amount of fuel supplied and an air ratio of the second-stage combustion air to the amount of fuel supplied from the intermediate nozzle stage is less than one.

6. The ammonia combustion furnace according to claim 5, wherein a sum of the air ratio of the first-stage combustion air to the amount of fuel supplied, an air ratio of the second-stage combustion air supplied from the intermediate nozzle stage, and an air ratio of the second-stage combustion air supplied from the most downstream nozzle stage is larger than one.

7. The ammonia combustion furnace according to claim 4, wherein a sum of an air ratio of the first-stage combustion air to the amount of fuel supplied and an air ratio of the second-stage combustion air to the amount of fuel supplied from the intermediate nozzle stage is less than one.

8. The ammonia combustion furnace according to claim 7, wherein a sum of the air ratio of the first-stage combustion air to the amount of fuel supplied, an air ratio of the second-stage combustion air supplied from the intermediate nozzle stage, and an air ratio of the second-stage combustion air supplied from the most downstream nozzle stage is larger than one.
